(19) United States
(12) Patent Application Publication
(10) Pub. No.: US 2006/0284832 A1
(43) Pub. Date: Dec. 21, 2006

(54) METHOD AND APPARATUS FOR LOCATING A LASER SPOT

(75) Inventor: Wen-Kai Kuo, Huwei (TW)

Correspondence Address: NIKOLAI & MERSEREAU, P.A., 900 SECOND AVENUE SOUTH, SUITE 820, MINNEAPOLIS, MN, 55402, US

(73) Assignee: H.P.B. OPTOELECTRONICS CO., LTD., Taichung Industrial Zone (TW)

(21) Appl. No.: 11/160,283

(22) Filed: Jun. 16, 2005

(51) Int. Cl. G09G 5/00

(52) U.S. Cl. 345/156

(57) ABSTRACT

Disclosed is a system for locating a laser spot on a screen. The system includes a projector, a laser pointer, a camera, a diffractive optical element, and a computer. The projector casts an image on the screen. The laser pointer casts the laser spot on the screen. The camera takes a picture corresponding to the image on the screen. The diffractive optical element is put between the screen and the camera in order to transform the laser spot into an easily observable diffractive pattern in the picture. The computer receives the picture from the camera and locates a semi-cursor on a display connected thereto based on the diffractive pattern in the picture.

### BACKGROUND OF INVENTION

1. Field of Invention

The present invention relates to a method and apparatus for locating a laser spot.

2. Related Prior Art

Projectors are commonly used for multimedia presentations in classes and conferences. In demonstration of software, a computer and a projector are often used. What is shown on the display of the computer is projected to a screen by means of the projector. If the computer is equipped with a Windows® type operation system, to control the computer, all the presenter has to do is move the cursor and click by means of a conventional trackball or mouse. A problem is that the presenter is confined in a small area around the computer in order to reach the trackball or mouse.

Nowadays, a presenter can carry a wireless trackball or mouse while presenting. The presenter uses the wireless trackball or mouse in order to control the cursor. However, the presenter may hold the wireless trackball in one hand and operate the wireless trackball in the other hand; this however looks stupid and causes pains and inconvenience for the presenter. The presenter may put the wireless trackball on a table; this however confines the presenter in a small area around the table. The presenter needs a table to support the wireless mouse; this however confines the presenter in a small area around the table. Moreover, it is difficult for the presenter to draw a line or a circle with drawing functions of presentation software such as PowerPoint.

To overcome the problems related to the use of the wireless trackball or mouse, there are devised systems including a laser pointer tracked by a position sensing device (PSD), a camera or other devices. Among these approaches, a camera is the most promising because of its relatively simple implementation.

Referring to FIG. 1, an exemplary conventional system for locating a laser spot includes a computer 14a, a projector 15a, a screen 26a, and a camera 13a. The computer 14a is equipped with a display 25a. An image 10a is cast on the screen 26a from the projector 15a. A scattering laser spot 17a is cast on the screen 26a from a laser pointer 16a. A user 30a pushes a button 31a on the laser pointer 16a in order to turn on the laser pointer 16a. The laser pointer 16a emits a laser beam 32a continuously. The image containing the laser spot 17 is taken by the camera 13a. Then, the image is sent to the computer 14a. The computer processes the image in order to identify the laser spot in the image and generates a semi-cursor 24a on the display 25a. The position of the semi-cursor 24a on the display 25a is determined based on that of the laser spot 17a on the screen 26a. An image-processing technique is used in order to locate the semi-cursor 24a.

The intensity of the laser spot is above a threshold in order to be observed. However, if any intense light spot is cast on the screen from the projector, even the intense light spot and the laser pointer are of different colors, it will be difficult to identify the laser spot. This is because the intense light spot saturates image sensors and the image is mistaken as white.

Another problem with the prior art is latency. Lags occur between the image sensing device and the computer. When the transmission rate is fixed, the picture rate is dependent on the image compression ratio. If the image compression ratio is higher, the picture rate can be increased, and lags obviated. Unfortunately, the images are usually complex and the compression ratio is not high. To increase the compression ratio, we have to reduce the high frequency components in the image, i.e. make the image fuzzy.

Moreover, the image-processing technique consumes much of the time of the central processing unit of the computer. This may also cause latency and hinder the computer from handling other task.

### SUMMARY OF INVENTION

According to the present invention, a system for locating a laser spot on a screen includes a projector, a laser pointer, a camera, a diffractive optical element, and a computer. The projector casts an image on the screen. The laser pointer casts the laser spot on the screen. The camera takes a picture corresponding to the image on the screen. The diffractive optical element is put between the screen and the camera in order to transform the laser spot into a diffractive pattern in the picture. The computer receives the picture from the camera and locates a semi-cursor on a display connected thereto based on the diffractive pattern in the picture.

An advantage of the method and apparatus for locating a laser spot according to the present invention is the transformation of the laser spot into the diffractive pattern that can easily be observed.

Other advantages and novel features of the invention will become more apparent from the following detailed description in conjunction with the drawings.

### BRIEF DESCRIPTION OF DRAWINGS

The present invention will be described through detailed illustration of the preferred embodiment referring to the drawings.

The invention will be better understood taken in conjunction with the detail descriptions in conjunction with the drawings of which:

FIG. 1 is a conventional system for locating a laser spot.

FIG. 2 is a system for locating a laser spot according to the preferred embodiment of the present invention.

FIG. 3 is an exemplary algorithm for locating the laser spot in the system shown in FIG. 2.

FIG. 4 shows an exemplary diffractive pattern obtained by means of subtracting a secondary image from a primary image.

FIG. 5 shows the mapping of an image sensor of a camera to a display of a computer.

FIGS. 6, 7 and 8 show three steps of a method for obtaining a boundary.

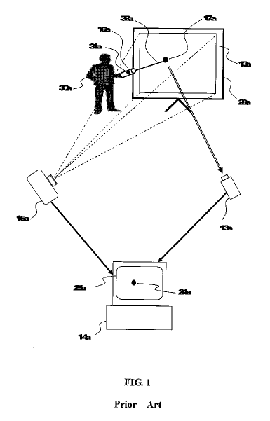

### DETAILED DESCRIPTION OF PREFERRED EMBODIMENT

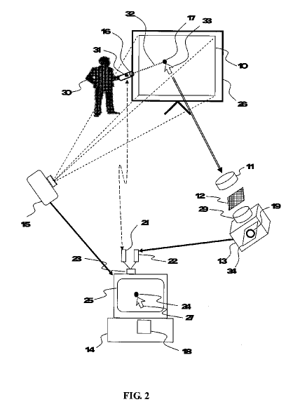

Referring to FIG. 2, a system for locating a laser spot according to the preferred embodiment of the present invention includes a computer 14, a projector 15, a laser pointer and wireless transceiver 16, a screen 26, a filter 11, a diffractive optical element (“DOE”) 12, a camera 13, an image interface device 22, and a wireless interface device 21.

The computer 14 includes a memory 18 that is configured in order to include two blocks. The computer 14 is equipped with a display 25.

An image 10 is cast on the screen 26 from the projector 15.

The laser pointer and wireless transceiver 16 includes a button 31. A user 30 can push the button 31 so as to cause the laser pointer and wireless transceiver 16 to emit a laser beam 32 intermittently, i.e., on and off. The on and off of the laser beam 32 change fast so that it may not be observed. As the laser beam 32 is on, it casts the laser spot 17 on the screen 26. On emitting the laser beam 32, the laser pointer and wireless transceiver 16 sends control signals to the computer 14 in order to locate a semi-cursor 24 on the display 25 and take actions such as the functions of a mouse.

The camera 13 includes an image sensor 34.

The operation of the system shown in FIG. 2 will be described with reference to FIG. 3.

At Step 100, the system is turned on.

At Step 101, the system is initialized. The size calibration of the image 10 on the screen 26 is conducted. The data obtained during this step will be used in locating the laser spot 17 on the screen 26.

At Step 102, it is determined whether the laser beam 32 is on. The system goes to Step 103 if the laser beam 32 is on and goes to Step 104 if otherwise.

At Step 103, a primary picture is taken of the screen 26 on which the image 10 and the laser spot 17 are both cast.

At Step 104, a secondary picture is taken of the screen 26 on which only the image 10 is cast.

Before the primary and secondary pictures are taken by means of the camera 13, they are filtered by means of the filter 11. Thus, colors different from that of the laser spot 17 are eliminated from the primary and secondary pictures. If the laser beam 32 is red, the blue and green color planes of each picture are removed. Thus, reduced is the amount of the data of the pictures to be processed by the computer 14.

The DOE 12 is a laser-specific element, i.e., it is sensitive to the laser spot 17 only. The laser spot 17 in the primary picture is transformed into a diffractive pattern 19. The diffractive pattern 19 is large and special compared with the laser spot 17 so that it can easily be observed. The DOE may be put before or after the filter 11.

The computer 14 transmits a picture signal to the laser pointer and wireless transceiver 16 to control the on and off of the laser beam 32. The computer 14 receives the primary and secondary pictures through the image interface device 22. The computer 14 stores the primary picture in a first block of the memory 18 and the secondary picture in a second block of the memory 18. Furthermore, the computer 14 locates the semi-cursor 24 on the display 25.

The computer 14 receives these control signals from the laser pointer and wireless transceiver 16 through a wireless interface device 21. The image data interface device 22 and the wireless interface device 21 may be combined into a single standard computer interface device 23 such as a USB interface device. To perform the functions of a mouse, we can set the position of a cursor 27 to be the same as that of the semi-cursor 24. A projection 33 of the cursor 27 is to follow the scattering laser spot 17 in the image 10.

At Step 105, it is determined whether the first and second blocks of the memory 18 are both full. The system goes to Step 106 if the first and second blocks of the memory 18 are both full and returns to Step 102 if otherwise.

If the time duration between the primary and second pictures is short enough, the secondary picture can be used as a background even when the image 10 is a motion image.

At Step 106, the secondary picture is subtracted from the primary picture. Thus, only the diffractive pattern 19 is left, and the background is removed. Hence, there is no need for any sophisticated image-process technique to identify the diffractive pattern 19.

At Step 107, a simple algorithm is used to locate the semi-cursor 24 on the display 25. The position of the semi-cursor 24 on the display 25 is determined based on that of the diffractive pattern 19 on the primary picture, and the position of the diffractive pattern 19 on the primary picture is determined based on that of the laser spot 17 on the screen 26. This position coordination can be used to control the cursor 27 to follow the scattering laser spot 17. If this is combined with the functions of a mouse, interactions with the computer 14 can be done.

Compared with a light spot obtained by means of subtracting a secondary picture from a primary picture without the use of the DOE 12, the diffractive pattern 19, such as a Christmas tree, is easily observable.

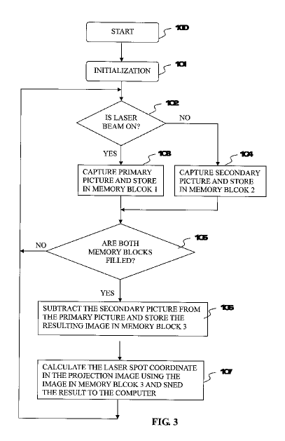

FIG. 4 shows an example 204 of the diffractive pattern.

A chart 205 shows the intensity values of pixels along a vertical line near the diffractive pattern 19. The vertical axis and the horizontal axis represent the position and the intensity value, respectively. The pixel intensity values around the diffractive pattern 19 are high, while the pixel intensity values in other positions are very low.

A chart 208 shows the intensity values of pixels along a horizontal line near the diffractive pattern 19. The vertical axis and the horizontal axis represent the position and the intensity value, respectively. The pixel intensity values around the diffractive pattern 19 are high, while the pixel intensity values in other positions are very low.

Lines of 206 and 207 represent the calculated center position of the diffractive pattern 19 on the vertical and the horizontal lines, respectively. The position corresponds to the pixel coordinate of the laser spot 17.

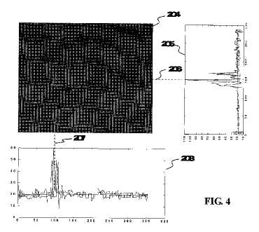

Referring to FIG. 5, to map the image sensor 34 to the display 25, the most important thing is to obtain a boundary 301 on the image sensor 34 formed by a lens 29 of the camera 13. The camera 13 may be an ordinary web camera with an image sensor size of 640×480 (326,400 pixels). The size of the image in the image sensor 34 of the camera 13 should be less than 640×480 and is practically 560×420 for example. However, the display 25 may be of VGA quality with an image size of 1024×768. Hence, the pixel coordinate defined by the boundary 301 on the image sensor 34 must be multiplied by a factor of 1.83 in order to be mapped to that of the VGA display 25.

However, if the light intensity of the background on the screen 26 is as high as that of the image 10, the contrast between them is low. Hence, it is difficult to identify the boundary 301 between them. A method is proposed to identify the boundary during Step 101.

Referring to FIG. 6, the projector 15 projects the most intense light so as to form an image 302 from which the image sensor 34 develops a most intense image 303.

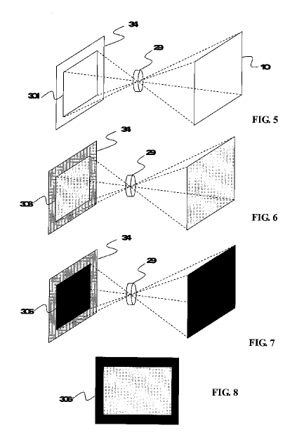

Referring to FIG. 7, the projector 15 projects the least intense light so as to develop an image 304 from which the image sensor 34 develops a least intense image 305.

Referring to FIG. 8, the most intense image 303 is subtracted from the least intense image 305, thus eliminating the background light effect. Thus, the boundary of the resultant image 306 appears.

The present invention has been described through the detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. An system for locating a laser spot on a screen, the system comprising:
a projector for casting an image on the screen;
a laser pointer for casting the laser spot on the screen;
a camera for taking a picture corresponding to the image on the screen;
a diffractive optical element put between the screen and the camera in order to transform the laser spot into an easily observable diffractive pattern in the picture; and
a computer for receiving the picture from the camera and locating a semi-cursor on a display connected thereto based on the diffractive pattern in the picture.

2. The system according to claim 1 wherein the laser pointer casts the laser spot intermittently, wherein the camera takes a secondary picture corresponding to the image without the laser spot and a primary picture corresponding to the image with the laser spot, wherein the computer subtracts the secondary picture from the primary picture, thus leaving the diffractive pattern only.

3. The system according to claim 2 wherein the computer comprises a memory with a block for storing the primary picture and another block for storing the secondary picture.

4. The system according to claim 2 wherein the laser pointer transmits control signals to the computer, wherein the computer transmits picture signals to the laser pointer in order to drive the laser pointer to cast the laser spot intermittently.

5. The system according to claim 4 wherein the laser pointer comprises a wireless transceiver through which the control signals are transmitted and the picture signals are received.

6. The system according to claim 4 wherein the computer comprises a wireless interface device through which the control signals are received and the picture signals are transmitted.

7. The system according to claim 1 comprising a filter put between the screen and the camera.

8. The system according to claim 7 comprising a filter put between the screen and the diffractive optical element.

9. The system according to claim 7 comprising a filter put between the diffractive optical element and the camera.

10. The system according to claim 1 wherein the computer comprises an image interface device through which the picture is received.

11. The according to claim wherein 1 the camera comprises an image sensor on which the picture is shown, wherein the projector projects two successive high-contrast images in order to obtain a boundary of the picture on the image sensor during the initiation thereof.

12. A method for locating a laser spot on a screen, the method comprising the steps of:
casting an image on the screen by means of a projector;
casting the laser spot on the screen by means of a laser pointer;
taking a picture corresponding to the image on the screen by means of a camera;
transforming the laser spot into an easily observable diffractive pattern in the picture by means of a diffractive optical element put between the screen and the camera; and
locating a semi-cursor on a display of a computer based on the diffractive pattern in the picture by means of the computer.

13. The method according to claim 12 wherein the step of casting the spot comprises the step of casting the laser spot intermittently, wherein the step of taking the picture comprises the step of taking a secondary picture corresponding to the image without the laser spot and the step of taking a primary picture corresponding to the image with the laser spot, wherein the step of locating the semi-cursor comprises the step of subtracting the secondary picture from the primary picture, thus leaving the diffractive pattern only.

14. The system according to claim 13 wherein the step of locating the semi-cursor comprises the step of storing the primary picture in a block of a memory of the computer and the step of storing the secondary picture in another block of the memory.
